(19) United States
(12) Patent Application Publication
(10) Pub. No.: US 2009/0214806 A1
(43) Pub. Date: Aug. 27, 2009

(54) INKJET RECORDING MEDIUM AND METHOD OF MANUFACTURING THE SAME

(75) Inventor: Masamichi Kobayashi, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/391,733

(22) Filed: Feb. 24, 2009

(30) Foreign Application Priority Data
Feb. 25, 2008 (JP) 2008-043533

(51) Int. Cl. B32B 5/16; B05D 3/00

(52) U.S. Cl. 428/32.25; 427/380

(57) ABSTRACT

The invention provides an ink jet recording medium having at least two ink absorbing layers provided on or above a non-water-absorbing support, wherein: a first ink absorbing layer, which is provided uppermost among the at least two ink absorbing layers, contains at least silanol-modified polyvinyl alcohol, polyaluminum chloride and pseudo boehmite alumina, and a second ink absorbing layer, which is adjacent to the first ink absorbing layer, contains at least pseudo boehmite alumina having a secondary particle diameter of 80 nm or less, polyvinyl alcohol, boric acid, and a water-soluble zirconium salt. The invention further provides a method of manufacturing the ink jet recording medium.

### CROSS-REFERENCE TO RELATED APPLICATION

This application claims priority under 35 USC 119 from Japanese Patent Application No. 2008-043533 filed on Feb. 25, 2008, the disclosure of which is incorporated by reference herein.

### BACKGROUND OF THE INVENTION

1. Technical Field

The present invention relates to an inkjet recording medium and a method of manufacturing the inkjet recording medium.

2. Description of the Related Art

Together with the recent rapid progress of the information technology industry, various information processing systems have been developed, and recording methods and recording media suitable to each system have been put into practice.

An inkjet recording method has become widely used from the viewpoint s that recording can be carried out on various recording materials, the hardware (device) is relatively inexpensive and compact and is superior in quietness. With recent development of high-resolution inkjet printers, hardware (device) and various inkjet recording media, so-called “photo-like” high quality images have become possible.

A recording material for inkjet recording is generally required to have the characteristics of: (1) quick-drying (high absorption rate of ink), (2) suitable and uniform dot size (no spreading), (3) excellent granularity, (4) high dot roundness, (5) high color density, (6) high chroma (no dullness), (7) excellent water resistance, light fastness and ozone resistance of an image region, (8) high whiteness, (9) high storage stability (no yellowing or image blurring in long-term storage), (10) excellent dimensional stability with less deformation (less curling), and (11) excellent traveling in hardware.

In view of the foregoing, a recording material having an ink-receiving layer with a porous structure has been put to practical use in recent years. This recording material is considered to achieve excellent quick-drying property and high gloss. However, there is a tendency for very high quality to be demanded for a recorded image, and in particular, there are strict requirements for color density and color tone of an image. For example, deep colors in a high density range are important for contrast and sharp shading of an image, and no generation of bronzing is important for color tone and colorfulness.

The term “bronzing” refers to a phenomenon in which the applied ink solidifies on the surface of an ink receiving layer rather than permeating into the ink receiving layer, such that the recorded image appears bronze-colored, and specifically in which a cyan image area appears reddish-colored. Also, a large degree of change in color of an image which occurs within a short period (for example, within a period of one hour) from immediately after formation of an image may deteriorate a photographic image quality of the image. Therefore, it is desirable for the recording material to undergo less discoloration.

In response to this demand, to obtain favorable ink absorbing properties and excellent image saturation, a method for producing an inkjet recording medium having a porous layer formed by coating, on a support, a coating composition containing a hydrophilic polymer and inorganic fine particles, in which the hydrophilic polymer and the inorganic fine particles form a gel and the coating composition contains the gel dispersed therein (see, for example, Japanese Patent Application Laid-Open (JP-A) No. 2002-293009), and a method for producing an inkjet recording medium having a porous layer formed by coating, on a support, a coating composition containing a hydrophilic polymer and inorganic fine particles, in which an acidic substance is added to the coating composition immediately before coating the coating composition on a support to cause gelation on the support (see, for example, JP-A No. 2002-283704) have been disclosed.

A recording medium provided with an ink receiving layer on a substrate, in which the ink receiving layer contains an alumina hydrate having a boehmite structure and a non-coupling zirconium compound (see, for example, JP-A No. 2000-71609), has been also disclosed as a recording medium capable of forming a printed area with a high optical density and a good transparency, and exhibiting excellent halftone reproduction particularly in the output of a photographic image.

Further, a recording sheet having an alumina hydrate layer formed on a substrate and containing one or more selected from zirconium salts, titanium salts, or cationic resins as a water resistance imparting material (see, for example, JP-A No. 10-226153) has been disclosed, for the purpose of obtaining a recorded matter having excellent ink absorbing properties, no bleeding, high color reproducibility, high color density, and excellent water resistance.

However, inkjet recording media produced by the method for producing an inkjet recording material as described in JP-A No. 2002-293009 or JP-A No. 2002-283704 may have a porous layer (ink absorbing layer) with a large pore size, which in some cases results in a low printed image density. Also, recording media or the recording sheets disclosed in JP-A No. 2000-71609 or JP-A No. 10-226153 may not always provide a sufficient printed image density.

### SUMMARY

The present invention has been made in consideration of the above-described conventional techniques, and provides an inkjet recording medium which can record an image which has a high recorded image density, which can prevent the occurrence of bronzing, and which suffers less discoloration, and a method of producing the same.

Namely, the present invention provides an ink jet recording medium comprising at least two ink absorbing layers provided on or above a non-water-absorbing support, wherein:

a first ink absorbing layer, which is provided uppermost among the at least two ink absorbing layers, comprises silanol-modified polyvinyl alcohol, polyaluminum chloride and pseudo boehmite alumina, and

a second ink absorbing layer, which is adjacent to the first ink absorbing layer, comprises pseudo boehmite alumina having a secondary particle diameter of 80 nm or less, polyvinyl alcohol, boric acid, and a water-soluble zirconium salt.

The present invention further provides a method of manufacturing an ink jet recording medium comprising at least two ink absorbing layers provided on or above a non-water-absorbing support, the method comprising:

applying, on or above the non-water-absorbing support, a first coating liquid comprising pseudo boehmite alumina having a secondary particle diameter of 80 nm or less, polyvinyl alcohol, boric acid, and a water-soluble zirconium salt;

drying the applied first coating liquid to form a second ink absorbing layer, which is adjacent to a first ink absorbing layer to be provided uppermost among the at least two ink absorbing layers;

applying, above the non-water-absorbing support, a second coating liquid comprising silanol-modified polyvinyl alcohol, polyaluminum chloride and pseudo boehmite alumina; and

drying the applied second coating liquid to form the first ink absorbing layer.

### DETAILED DESCRIPTION

Inkjet Recording Medium

The inkjet recording medium of the invention has at least two ink absorbing layers provided on or above a non-water-absorbing support. A first ink absorbing layer, which is provided uppermost among the at least two ink absorbing layers, contains at least silanol-modified polyvinyl alcohol, polyaluminum chloride and pseudo boehmite alumina. A second ink absorbing layer, which is adjacent to the first ink absorbing layer, contains at least pseudo boehmite alumina having a secondary particle diameter of 80 nm or less, polyvinyl alcohol, boric acid, and a water-soluble zirconium salt.

The first ink absorbing layer, which contains at least silanol-modified polyvinyl alcohol, polyaluminum chloride and pseudo boehmite alumina has excellent ink absorbing property. Hence, occurrence of blonzing can be suppressed by providing the first ink absorbing layer as the uppermost layer. However, presence of the first ink absorbing layer alone may in some cases fail to provide a sufficient density of a recorded image. Improvement in a density of recorded image and suppression of discoloration of the recorded image can be attained by providing the second ink absorbing layer, which contains at least pseudo boehmite alumina having a secondary particle diameter of 80 nm or less, polyvinyl alcohol, boric acid and water-soluble zirconium salt, so that the second ink absorbing layer is in contact with the first ink absorbing layer.

In general, addition of a zirconium salt to the ink absorbing layer may cause reduction in recorded image density in some cases. On the other hand, the inkjet recording medium of the invention, that contains the water-soluble zirconium salt in the second ink absorbing layer, can improve density of the recorded image.

First Ink Absorbing Layer

The first ink absorbing layer of the inkjet recording medium of the invention contains at least silanol-modified polyvinyl alcohol, polyaluminum chloride, and pseudo boehmite alumina.

The silanol-modified polyvinyl alcohol to be used in the first ink absorbing layer can be produced by a conventionally known synthesizing process described in, for example, Die Angewandte Markromolekulare chemie 81, 137 (1979). Vinyltrimethoxysilane and vinyl acetate are copolymerized with each other in methanol or the like, and subsequently the vinyl acetate is saponified by methanolysis using sodium hydroxide as a catalyst to obtain a desired polymer. The silanol-modified polyvinyl alcohol preferably has a saponification degree of 85% or more and a polymerization degree of about 500 to about 2,000, and a content of silanol group in the molecule of the silanol-modified polyvinyl alcohol is preferably 0.05 mol % to 3 mol % in terms of monomer unit. Commercially available silanol-modified polyvinyl alcohols can preferably be used as such silanol-modified polyvinyl alcohol. Examples thereof include R-1115, R-1130, R-2105, and R-2130 (all trade names; manufactured by KURARAY CO., LTD.).

Other water-soluble or hydrophilic high molecular compound may be used in combination with the silanol-modified polyvinyl alcohol in the first ink absorbing layer. Examples of the other high molecular compound include polyvinyl alcohol and a modified product thereof, acrylic resin, styrene-acryl copolymer, maleic anhydride polymer, styrene-maleic anhydride copolymer, ethylene-vinyl acetate copolymer, starch, polyvinyl butyral, gelatin, casein, an ionomer, gum arabi, carboxymethyl cellulose, alginic acid, sodium alginate, pullulan, polyvinylpyrrolidone, polyacrylamide, polyethylene glycol, and polypropylene glycol.

In the case of using the other water-soluble or hydrophilic high molecular compound in combination with the silanol-modified polyvinyl alcohol, the content of the silanol-modified polyvinyl alcohol with respect to the total amount of the silanol-modified polyvinyl alcohol and the other high molecular compound is preferably in a range of 5% by mass to 80% by mass, more preferably in a range of 10% by mass to 70% by mass, and particularly preferably in a range of 20% by mass to 50% by mass.

The polyaluminum chloride contained in the first ink absorptive layer is preferably a water-soluble aluminum compound which is a water-soluble polyaluminum hydroxide, the main component of which is represented by the following formula 1, 2 or 3 and which stably contains a basic and high molecular polynuclear condensation ion such as [Al₆(OH)₁₅]³⁺, [Al₈(OH)₂₀]⁴⁺, [Al₁₃(OH)₃₄]⁵⁺, or [Al₂₁(OH)₆₀]³⁺.

[Al₂(OH)ₙCl₆₋ₙ]ₘ Formula 1

[Al(OH)₃]nAlCl₃ Formula 2

Iₙ(OH)ₘCl₍₃ₙ₋ₘ₎0<m<3n Formula 3

These compounds of various grades can be easily obtained as commercially available products such as a water treatment agent (trade name: POLYALUMINUM CHLORIDE (PAC), manufactured by Taki Chemical Co. Ltd.), POLYALUMINUM HYDROXIDE (PAHO) (trade name, manufactured by Asada Kagaku Co. Ltd.), ALFINE (trade name, manufactured by Taimei CHEMICALS Co., Ltd.), or PURACHEM WT (trade name, basic aluminum chloride, manufactured by Riken Green Co. Ltd.). Commercial products of these compounds for the similar applications are also available from other manufacturers. These commercially available products can be used directly in the invention.

Polyaluminum chloride is used for gelling the silanol-modified polyvinyl alcohol. The amount of polyaluminum chloride added to the first ink absorbing layer is preferably in a range of 50 parts by mass to 400 parts by mass, more preferably in a range of 75 parts by mass to 300 parts by mass, and particularly preferably in a range of 100 parts by mass to 200 parts by mass, per 100 parts by mass of the silanol-modified polyvinyl alcohol contained in the first ink absorbing layer.

The pseudo boehmite alumina contained in the first ink absorbing layer is an alumina hydrate and can be represented by the following Formula (4).

Al₂O₃·nH₂O Formula (4)

Specifically, Formula (4) represents an alumina hydrate having a boehmite structure when n is 1. Formula (4) represents an alumina hydrate having a pseudo boehmite structure when n is larger than 1 and is smaller than 3. Formula (4) represents an alumina hydrate having an amorphous structure when n is equal to or larger than 3.

The alumina hydrate can provide a remarkable effect in fixing a colorant such as a dye used in an ink onto the recording medium due to the cationic properties of its surface. The alumina hydrate can be thus preferable since it may enable to reduce the addition amount, or eliminate the addition, of a mordant such as a cationic polymer, which serves to reduce production of offensive smell from recorded products.

The primary particle diameter of pseudo boehmite to be used in the first ink absorbing layer is preferably 100 ni or less, more preferably 30 nm or less, and particularly preferably 15 nm or less. Also, the secondary particle diameter of pseudo boehmite to be used in the first ink absorbing layer is preferably 300 nm or less, more preferably 150 nm or less, and particularly preferably 100 nm or less.

The average pore radius of pseudo boehmite is preferably in a range of 1 nm to 10 nm, and is more preferably in a range of 3 nm to 7 nm in view of providing a sufficient ink absorbing speed to the pseudo boehmite alumina. In case when the pore radius is too small, absorption of an ink may become difficult, whereas when the pore radius is too large, fixing of a dye in an ink onto the recording medium may become poor, which may lead to bleeding of an image formed of the ink.

The pore volume of the alumina hydrate in the ink absorbing layer is preferably in the range of 0.3 ml/g to 0.8 ml/g, and is more preferably in the range of 0.4 ml/g to 0.6 ml/g in view of providing a sufficient ink absorption capacity to the pseudo boehmite alumina. When the pore volume is too large, cracking or dusting may occur in the ink absorbing layer, whereas when the pore volume is too small, the absorption of an ink may become slow. The solvent absorbing amount per unit area of the ink absorbing layer is preferably 5 ml/m² or more, and is more preferably 10 ml/m² or more. When the solvent absorbing amount per unit area is smaller than that, overflow of an ink may occur, particularly when multi-color printing is performed.

The BET specific surface area of the pseudo boehmite alumina is preferably in the range of 70 m²/g to 300 m²/g in view of sufficient absorption of a dye contained in ink by the pseudo boehmite alumina so that an image formed of the ink can be fixed onto the recording medium. In case when the BET surface area is too small, the pore diameter distribution may deviate to a larger pore diameter to lead to deterioration in the effect of fixation a dye contained in ink onto the recording medium to cause image bleeding. On the other hand, when the BET specific surface area is too large, dispersion of the pseudo boehmite alumina can become difficult.

The shape of the pseudo boehmite alumina to be used in the invention may be any of a tabular shape, a fiber shape, a needle shape, a spherical shape, a rod shape, and the like. In view of ink absorbing property, a tabular shape is preferable. An average aspect ratio of the pseudo boehmite alumina having a tabular shape is typically from 3 to 8, and is preferably from 3 to 6. The aspect ratio can be represented in terms of a ratio of a diameter of a particle to a thickness of the particle. The “diameter” of a particle herein means a diameter of a circle having the same area as the projected area of the alumina hydrate particle determined by observing the particle under an electron microscope. When the aspect ratio is smaller than the above range, the pore diameter distribution of the ink absorbing layer may become narrow, possibly leading to reduction of ink absorbing property of the ink absorbing layer. On the other hand, when the aspect ratio exceeds the above range, production of the pseudo boehmite alumina with substantially uniform particle size can become difficult.

The alumina hydrate can be produced by a known process such as hydrolysis of aluminum alkoxide, e.g., aluminum isopropoxide, neutralization of an aluminum salt with an alkali, or hydrolysis of an aluminate. Physical properties of the alumina hydrate such as particle diameter, pore diameter, pore volume, or specific surface area can be controlled by properly selecting the production condition such as precipitation temperature, aging temperature, aging period, pH of the reaction solution, concentration of the reaction solution, co-existing compounds, and the like.

Examples of the process for obtaining the alumina hydrate from an alkoxide include hydrolyzing an aluminum alkoxide, as disclosed in JP-A Nos. 57-88074, 2-56321, 4-275917, 6-64918, 7-10535, and 7-267633, U.S. Pat. No. 2,656,321. Examples of the aluminum alkoxide include aluminum isopropoxide and aluminum 2-butoxide.

Examples of the process for obtaining the alumina hydrate further include a process including using an inorganic salt of aluminum or a hydrate thereof as a starting material, as described in JP-A Nos. 54-116398, 55-23034, 55-27824, and 56-120508. Examples of the starting material in such a process include aluminum chloride, aluminum nitrate, aluminum sulfate, polyaluminum chloride, ammonium alum, sodium aluminate, potassium aluminate, aluminum hydroxide, and hydrates thereof.

Examples of the process for obtaining the alumina hydrate further include a process of varying pH between the acid side and the basic side to grow up alumina hydrate as described in JP-A No. 56-120508, and a process including mixing alumina hydrate obtained from an inorganic salt of aluminum with alumina obtained by Bayer's process to rehydrating alumina as described in JP-B No. 4-33728.

Inorganic fine particles other than the pseudo boehmite alumina can be further contained in the first ink absorbing layer in combination. Examples of such other inorganic fine particles include alumina hydrate having a boehmite structure represented by Formula (4) in which n is 1, alumina hydrate having an amorphous structure represented by Formula (4) in which n is 3 or more, colloidal silica as described in JP-A Nos. 60-219083, 1-19389, 1-188183, 3-178074, and 5-51470, silica/alumina hybrid sol as described in JP-B No. 4-19037 and JP-A No. 62-286787, silica sol as obtained by dispersing ultra-fine silica particles with a high-speed homogenizer as described in JP-A Nos. 10-119423 and 10-217601, smectite clay such as hectite or montmorillonite (see JP-A No. 7-81210), zirconia zol, chromia sol, yttria sol, ceria sol, iron oxide sol, zircon sol, and antimony oxide sol.

Commercially-available inorganic fine particles can be suitably used as the pseudo boehmite alumina and/or the arbitrary other inorganic fine particles. Examples thereof includes the followings, while the invention is not limited thereby.

Examples of such commercially-available alumina hydrate include CATALOID AS-1, CATALOID AS-2, and CATALOID AS-3 (all trade names, manufactured by Catalysts & Chemicals Industries Co., Ltd.); ALUMINA SOL 100, ALUMINA SOL 200, and ALUMINA SOL 520 (all trade names, manufactured by Nissan Chemical Industries, Ltd.); M-200 (trade name, manufactured by Mizusawa Industrial Chemicals, Ltd.); and ALUMI SOL 10, ALUMI SOL 20, ALUMI SOL 132, ALUMI SOL 132S, ALUMI SOL SH5, ALUMI SOL CSA55, ALUMI SOL SV102, and ALUMI SOL SB52 (all trade names, manufactured by Kawaken Fine Chemicals Co., Ltd.). Examples of such commercially-available colloidal silica include SNOWTEX® 20, SNOWTEX® 30, SNOWTEX® 40, SNOWTEX® S, SNOWTEX® O, SNOWTEX® C, SNOWTEX® N, SNOWTEX® 20L, SNOWTEX® UP, SNOWTEX® OL, SNOWTEX® AK, SNOWTEX® PST-1, SNOWTEX® K, SNOWTEX® XS, SNOWTEX® SS, SNOWTEX® XL, SNOWTEX® YL, SNOWTEX® ZL, SNOWTEX® PST-1, SNOWTEX® PST-3, SNOWTEX(O PST-5, MA-ST, IPA-ST, NBA-ST, IBA-ST, EG-ST, XBA-ST, ETC-ST, and DMAC-ST (all trade names, manufactured by Nissan Chemical Industries,Ltd.), CATALOID S-20L, CATALOID S-20H, CATALOID S-30L, CATALOID S-30H, CATALOID SI-30, CATALOID SI-40, CATALOID SI-50, CATALOID SI-350, CATALOID SI-45P, CATALOID SI-80P, CATALOID SN, CATALOID SA, CATALOID SB, USB-1, USB-2, USB-3, OSCAL1132, OSCAL1232, OSCAL1332, OSCAL1432, OSCAL1532, OSCAL1622, and OSCAL1722 (all trade names, manufactured by Catalysts & Chemicals Industries Co., Ltd.). Examples of such commercially-available silica/alumina hybrid sol include SNOWTEX%) UP-AK1, SNOWTEX® UP-AK2, and SNOWTEX® UP-AK3 (manufactured by Nissan Chemical Industries,Ltd.). Examples of such commercially-available antimony oxide sol include A-1530, A-1550, and A-2550 (all trade names, manufactured by Nissan Chemical Industries,Ltd.). Examples of such commercially-available lithium silicate include LITHIUM SILICATE 35, LITHIUM SILICATE 45, and LITHIUM SILICATE 75 (all trade names, manufactured by;Nissan Chemical Industries,Ltd.).

In the case of using other inorganic fine particles in combination with the pseudo boehmite alumina, the content of the pseudo boehmite alumina with respect to the total amount of the pseudo boehmite alumina and the other inorganic fine particles is preferably in a range of 70% by mass to 100% by mass, more preferably in a range of 80% by mass to 100% by mass, and particularly preferably in a range of 90% by mass to 100% by mass.

The content of pseudo boehmite alumina in the first ink absorbing layer is preferably less than 0.5 g/m², more preferably 0.3 g/m² or more and less than 0.5 g/m², and particularly preferably 0.4 g/m² or more and less than 0.5 g/m². When the content of pseudo boehmite alumina is less than 0.5 g/m², density of an image recorded on the recording medium of the invention can be maintained at a high level.

Regarding the total amount of the silanol-modified polyvinyl alcohol and other water-soluble- or hydrophilic-high molecular compound which can be arbitrarily used as needed in combination with the silanol-modified polyvinyl alcohol and the total amount of the pseudo boehmite alumina and other inorganic fine particles which can be arbitrarily used as needed in combination with the boehmite alumina, the ratio of the total amount of the silanol-modified polyvinyl alcohol and other water-soluble- or hydrophilic-high molecular compound which can be arbitrarily used as needed in combination with the silanol-modified polyvinyl alcohol can be typically in a range of 2% by mass to 80% by mass, and is preferably in a range of 5% by mass to 50% by mass, with respect to the total amount of the pseudo boehmite alumina and other inorganic fine particles which can be arbitrarily used as needed in combination with the boehmite alumina. When the addition amount is smaller than the above range, gel formation can be small, whereas when the addition amount exceeds the above range, too much gel may be formed to make re-dispersion be difficult.

A hydrophilic adhesive may be used in combination with the silanol-modified polyvinyl alcohol in the first ink absorbing layer. The hydrophilic adhesive can be a water-soluble- or hydrophilic-high molecular compound. Examples of the water-soluble high molecular compound include polyvinyl alcohol and a modified product thereof, acrylic resin, styrene-acryl copolymer, maleic anhydride polymer, styrene-maleic anhydride copolymer, ethylene-vinyl acetate copolymer, starch, polyvinyl butyral, gelatin, casein, an ionomer, gum arabi, carboxymethyl cellulose, alginic acid, sodium alginate, pullulan, polyvinylpyrrolidone, polyacrylamide, polyethylene glycol, and polypropylene glycol.

Various known additives such as a surfactant, an inorganic pigment, a colored dye, a colored pigment, an ink dye-fixing agent (cationic resin), an ultraviolet ray absorbent, an antioxidant, a dispersing agent for pigments, a defoaming agent, a leveling agent, an antiseptic, a fluorescent brightening agent, a viscosity-stabilizing agent, or a hardening agent may also be added to the first ink absorbing layer as needed.

Second Ink Absorbing Layer

The second ink absorbing layer of the inkjet recording medium of the invention contains at least pseudo boehmite alumina having a secondary particle diameter of 80 nm or less, polyvinyl alcohol, boric acid, and a water-soluble zirconium salt.

The secondary particle diameter of the pseudo boehmite alumina used in the second ink absorbing layer is 80 nm or less. In the invention, the “secondary particle diameter of pseudo boehmite alumina” means that obtained by subjecting pseudo bohemite alumina contained in a coating solution (dispersion) for forming the ink absorbing layer to measurment using SEM or TEM.

Preferable physical properties of the pseudo bohemite alumina contained in the second ink absorbing layer other than the secondary particle diameter and specific examples of other inorganic fine particles which can be used in combination with the pseudo bohemite alumina in the second ink absorbing layer are the same as physical properties and specific examples of those employed for the first ink absorbing layer.

In the case of using other inorganic fine particles in combination with the pseudo boehmite alumina in the second ink absorbing layer, the content of the pseudo boehmite alumina with respect to the total amount of the pseudo boehmite alumina and the other inorganic fine particles is preferably in a range of 80% by mass to 100% by mass, more preferably in a range of 90% by mass to 100% by mass, and particularly preferably in a range of 95% by mass to 100% by mass.

Examples of the polyvinyl alcohol used in the second ink absorbing layer include completely- or partially-saponified polyvinyl alcohol. Of polyvinyl alcohols, partially saponified polyvinyl alcohols having a saponification degree of 80% or more and completely saponified polyvinyl alcohols are particularly preferable. The polyvinyl alcohol preferably has a weight-average polymerization degree of 200 to 5,000.

Water-soluble- or hydrophilic-high molecular compound other than the polyvinyl alcohol can be used in the second ink absorbing layer in combination with the polyvinyl alcohol. Specific examples of the other high molecular compound include hydrophilic polymers such as modified products of polyvinyl alcohol, acrylic resin, styrene-acryl copolymer, maleic anhydride polymer, styrene-maleic anhydride copolymer, ethylene-vinyl acetate copolymer, starch, polyvinyl butyral, gelatin, casein, an ionomer, gum arabic, carboxymethyl cellulose, alginic acid, sodium alginate, pullulan, polyvinylpyrrolidone, polyacrylamide, polyethylene glycol, or polypropylene glycol.

When the other water-soluble- or hydrophilic-high molecular compound is used in combination with the polyvinyl alcohol in the second ink absorbing layer, the content of the polyvinyl alcohol with respect to the total amount of the polyvinyl alcohol and the other high molecular compound is preferably in a range of 50% by mass to 100% by mass, more preferably in a range of 70% by mass to 100% by mass, and particularly preferably in a range of 85% by mass to 100% by mass.

Regarding the total amount of the polyvinyl alcohol and the other water-soluble- or hydrophilic-high molecular compound which can be arbitrarily used as needed in combination with the polyvinyl alcohol and the total amount of the pseudo boehmite alumina and other inorganic fine particles which can be arbitrarily used as needed in combination with the boehmite alumina, the ratio of the total amount of the polyvinyl alcohol and the other water-soluble- or hydrophilic-high molecular compound which can be arbitrarily used as needed in combination with the polyvinyl alcohol can be typically in a range of 2% by mass to 80% by mass, and is preferably in a range of 5% by mass to 50% by mass, with respect to the total amount of the pseudo boehmite alumina and other inorganic fine particles which can be arbitrarily used as needed in combination with the boehmite alumina. When the addition amount is smaller than the above range, gel formation can be small, whereas when the addition amount exceeds the above range, too much gel may be formed to make re-dispersion be difficult.

Boric acid is used for gelling polyvinyl alcohol in the second ink absorbing layer. The addition amount of the boric acid to the second ink absorbing layer is preferably in a range of 10 parts by mass to 30 parts by mass, more preferably in a range of 15 parts by mass to 25 parts by mass, and particularly preferably in a range of 18 parts by mass to 23 parts by mass, per 100 parts by mass of polyvinyl alcohol contained in the second ink absorbing layer.

Examples of the water-soluble zirconium salt used in the second ink absorbing layer include zirconium acetate, zirconium chloride, zirconium oxychloride, zirconium hydroxychloride, zirconium nitrate, basic zirconium carbonate, zirconium hydroxide, zirconium lactate, zirconium ammonium carbonate, zirconium potassium carbonate, zirconium sulfate, and zirconium fluoride compounds. Of these, zirconium acetate is preferable.

The expression that a substance is “water-soluble” herein means that the substance can be dissolved at a concentration of 1% by mass or more in water at 20° C.

The addition amount of the water-soluble zirconium salt is preferably 2.5% by mass or more and less than 30% by mass, and more preferably in a range of 5% by mass to 25% by mass, with respect to the total amount of the pseudo boehmite alumina and the other inorganic fine particles used as needed.

Various known additives such as a surfactant, an inorganic pigment, a colored dye, a colored pigment, an ink dye-fixing agent (cationic resin), an ultraviolet ray absorbent, an antioxidant, a dispersing agent for pigments, a defoaming agent, a leveling agent, an antiseptic, a fluorescent brightening agent, a viscosity-stabilizing agent, or a hardening agent may also be added to the second ink absorbing layer as needed.

A hydrophilic adhesive may be used in the second ink absorbing layer. The hydrophilic adhesive can be a water-soluble- or hydrophilic-high molecular compound. Examples of the water-soluble high molecular compound include polyvinyl alcohol and a modified product thereof, acrylic resin, styrene-acryl copolymer, maleic anhydride polymer, styrene-maleic anhydride copolymer, ethylene-vinyl acetate copolymer, starch, polyvinyl butyral, gelatin, casein, an ionomer, gum arabi, carboxymethyl cellulose, alginic acid, sodium alginate, pullulan, polyvinylpyrrolidone, polyacrylamide, polyethylene glycol, and polypropylene glycol.

Non-Water-Absorbing Support

There is no particular limitation to the non-water-absorbing support to be used in the invention. Any of a non-water-absorbing support composed of a transparent material such as a plastic material, a resin-coated paper formed by providing a thermoplastic resin layer on each side of a non-transparent material such as paper, and the like can be used.

Use of the non-water-absorbing support may ensure high smoothness of the recording medium after recording an image.

The term “non-water-absorbing” herein means that an absorptiveness of a support is 1 g/m2 or less in terms of Cobb absorptiveness.

A non-water-absorbing transparent support or a non-water-absorbing high-gloss opaque paper can be preferably used as the non-water-absorbing support in the invention in view of employing the advantage of transparency of the ink absorbing layer.

Examples of a material which is preferable as that used for the transparent support include a material which is transparent and resistant against radiation heat generated in an OHP or a backlight display. Specific examples of such material include polyesters such as polyethylene terephthalate (PET), polysulfone, polyphenylene oxide, polyimide, polycarbonate, and polyamide. Preferable examples thereof include polyesters, and particularly preferable examples thereof include polyethylene terephthalate.

The thickness of the transparent support is not particularly limited, while a thickness of from 50 μm to 200 μm is preferable therefor in view of easiness in handling.

The non-water-absorbing support used in the invention can be more preferably a resin-coated paper in view of touch feeling, high-grade looking, and easiness in embossing.

There is no particular limitation to a base paper for the resin-coated paper to be preferably used in the invention, and commonly used paper can be used, while preferable examples thereof include a base paper having a smooth surface and a high density. Natural pulp, regenerated pulp, synthetic pulp, and/or the like can be used independently or in combination of two or more thereof as pulp for forming the base paper,. Any pulp commonly used for manufacturing paper, i.e., bleached chemical pulp such as conifer kraft pulp, broad-leaved tree kraft pulp, conifer sulfite pulp, or broad-leaved tree sulfite pulp can be used as the natural pulp. The pulp may be mechanical pulp having a high whiteness. Further, the pulp may be non-wood pulp produced from fibers of grass such as straw, esparto, bagasse, or kenaf, bast fibers such as hemp, paper mulberry (Broussonetia papyrifera), ganpi (Dipromorpha sikokiana), or mitsumata (Edgeworthia chrysantha); or cotton. Of these, bleached chemical pulp such as conifer kraft pulp, broad-leaved tree kraft pulp, conifer sulfite pulp, or broad-leaved tree sulfite pulp, which is most popularly used in the industrial field, is particularly preferable.

The pulp can be typically subjected to beating in a beater such as a double-disk refiner in order to improve various properties of paper including strength, smoothness, and evenness of formation. A degree of the beating can be selected within a common range of from 250 ml to 450 ml in terms of Canadian standard freeness according to the purpose.

The beaten pulp slurry is then formed into paper in a paper machine such as a Fourdrinier paper machine, a twin-wire paper machine, or a cylinder mould machine. In the invention, various additives which can be usually used in making paper such as a dispersing aid for the pulp slurry, a dry paper strength-enhancing agent, a wet paper strength-enhancing agent, a filler, a sizing agent, or a fixing agent can be added in this process as needed. Further, a pH adjusting agent, a dye, a color pigment, a fluorescent brightening agent, or the like can be added as needed.

Examples of the dispersing aid include polyethylene oxide, polyacrylamide, and hibiscus. Examples of the paper strength-enhancing agent include an anionic paper strength-enhancing agent such as plant gum, starch, or carboxy-modified polyvinyl alcohol, and a cationic paper strength-enhancing agent such as cationic starch, cationic polyacrylamide, or polyamidopolyamine epichlorohydrin resin. Examples of the filler include clay, kaolin, talc, calcium carbonate, barium sulfate, titanium oxide, aluminum hydroxide, and magnesium hydroxide. Examples of the sizing agent include a higher fatty acid salt, rosin, compounds obtained by modifying rosin (e.g., maleic rosin), dialkylketene dimer, alkenylsuccinic acid salt, alkylsuccinic acid salt, epoxylated fatty acid amide, and polysaccharide ester. Examples of the fixing agent include a polyvalent metal salt (e.g., aluminum sulfate or aluminum chloride), cationic starch, and cationic polymer (e.g., polyamidopolyamine epichlorohydrine resin). Examples of the pH adjusting agent include hydrochloric acid, sodium hydroxide, and sodium carbonate.

The base paper for the resin-coated paper which can be used in the invention may be subjected to surface sizing treatment such as tab sizing or size pressing with a liquid containing various additives such as a water-soluble high molecular additive.

Examples of the water-soluble high molecular additive include: starch compounds such as starch, cationic starch, oxidized starch, etherified starch, or phosphorylated starch; a polyvinyl alcohol compound such as polyvinyl alcohol or carboxy-modified polyvinyl alcohol, a cellulose compound such as carboxymethyl cellulose, hydroxymethyl cellulose, hydroxyethyl cellulose, or cellulose sulfate; a water-soluble natural polymer (e.g., gelatin, casein, or soybean protein); a water-soluble polymer (e.g., sodium polyacrylate, sodium salt of styrene-maleic anhydride copolymer, sodium polystyrenesulfonate, or maleic anhydride resin); and a water-soluble high molecular adhesive (e.g., a thermosetting synthetic resin such as melamine resin or urea resin). Examples of the sizing agent include a petroleum resin emulsion, ammonium salt of styrene-maleic anhydride copolymer alkyl ester, an alkylketene dimer emulsion, and a dispersion of, for example, styrene-butadiene copolymer, ethylene-vinyl acetate copolymer, polyethylene, or polyvinylidene chloride. Other additives such as an antistatic agent, a hygroscopic agent, a pigment, a pH adjusting agent can be also used. Examples of the antistatic agent include sodium chloride, calcium chloride, and Glauber's salt. Examples of the hygroscopic agent include glycerin and polyethylene glycol. Examples of the pigment include clay, kaolin, talc, barium sulfate, and titanium oxide. Examples of the pH adjusting agent include hydrochloric acid, sodium hydroxide, and sodium carbonate. Examples of the other additives further include dyes, fluorescent brightening agents, antioxidants, or ultraviolet ray absorbents, which may also be used in combination.

The base paper is preferably a paper having high surface smoothness by being compressed by pressurization with a calender or the like during or after paper making. It is particularly preferably a paper having a Bekk smoothness of 200 seconds or more as determined in accordance with JIS-P-8119. The basis weight of the base paper is preferably in the range of 30 g/m² to 250 g/m².

Examples of the resin for the resin-coated paper include hermoplastic resins and electron beam-curable resins. Examples of the thermoplastic resins include polyolefin resin and polyester resin. Examples of the polyolefin resin include olefin homopolymers of an olefin such as low-density polyethylene, high-density polyethylene, polypropylene, polybutene, or polypentene, copolymers composed of two or more olefins such as ethylene-propylene copolymer, and a mixture thereof. Examples of the polyester resin include polyethylene terephthalate, polybutylene terephthalate, and polyethylene naphthalate. These thermoplastic resins may be resins with various densities and melt viscosity indexes (melt index) and can be used independently or as a mixture of two or more thereof. Of them, polyethylene resin and polypropylene resin are preferable.

Various additives such as a white pigment (e.g., titanium oxide, zinc oxide, talc, or calcium carbonate), a fatty acid amide (e.g., stearic acid amide or arachidic acid amide), a fatty acid metal salt (e.g., zinc stearate, calcium stearate, aluminum stearate, or magnesium stearate), a blue pigment or dye (e.g., cobalt blue, ultramarine, cecilian blue, or phthalocyanine blue), a magenta pigment or dye (e.g., cobalt violet, fast violet, or manganese violet), a fluorescent brightening agent, an ultraviolet ray absorbent, or an antioxidant can be preferably added to the resin for the resin-coated paper in a proper combination.

The resin-coated paper, which can be preferably used as the support, can be produced by an extrusion-coating method in which a thermally molten resin is cast on a traveling base paper when the resin is a thermoplastic resin such as a . For improving adhesiveness between the resin and the base paper, the base paper is preferably subjected to an activation treatment such as a polyolefin resin or a polyester resin. The thus-formed resin-coated paper has a coating formed of the resin at a surface on which the ink absorptive layer is to be provided or at both surfaces thereof. Alternatively, the resin-coated paper can be formed by coating a resin with a generally-used coater such as a gravure coater, a blade coater or the like and irradiating the coated resin with electron beam so as to cure the coated resin, when the resin is curable with electron beam. The base paper is preferably subjected to a corona discharge treatment or flame treatment before it is covered with a resin.

It is not necessary that a reverse surface, which is opposite to the upper surface on which the ink absorptive layer is to be provided, of the support is coated with a resin, while it is preferable that the reverse surface is coated with a resin in order to prevent curling. While the reverse surface is usually a matt surface, the upper surface alone or both the upper and reverse surfaces may be subjected to an activation treatment such as a corona discharge treatment or a flame treatment if necessary. There is no particular limitation to the thickness of the resin coating layer, while the resin coating provided at a surface of the support on which the ink absorptive layer is to be provided or at both surfaces thereof generally has the thickness of 5 μm to 50 μm.

It is preferable to provide an undercoat layer to the surface side of the non-water-absorbing support onto which the ink absorptive layer is applied. The undercoat layer is provided by applying, before applying the ink absorptive layer, a material for forming the undercoat layer onto the surface of the non-water-absorbing support by coating and drying or the like. The undercoat layer contains, as a main component thereof, a water-soluble polymer or a polymer latex (preferable examples thereof include water-soluble polymers such as gelatin, polyvinyl alcohol, polyvinyl pyrrolidone, or water-soluble cellulose, and particularly preferable examples thereof include gelatin) capable of forming the coating film. The coating amount of the water-soluble polymer on the surface of the support is preferably 10 mg/m² to 500 mg/m², and more preferably 20 mg/m² to 300 mg/m². It is preferable that the undercoat layer further contains a surfactant, a crosslinking agent and/or the like. The non-water-absorbing support is preferably subjected to a corona discharge treatment before the undercoat layer is applied thereto.

Method of Manufacturing Inkjet Recording Medium

The method of manufacturing an ink jet recording medium of the invention is that for forming an ink jet recording medium having at least two ink absorbing layers provided on or above a non-water-absorbing support. Specifically, the method includes at least: applying, on or above the non-water-absorbing support, a first coating liquid comprising pseudo boehmite alumina having a secondary particle diameter of 80 nm or less, polyvinyl alcohol, boric acid, and a water-soluble zirconium salt; drying the applied first coating liquid to form a second ink absorbing layer, which is adjacent to a first ink absorbing layer to be provided uppermost among the at least two ink absorbing layers; applying, above the non-water-absorbing support, a second coating liquid comprising silanol-modified polyvinyl alcohol, polyaluminum chloride and pseudo boehmite alumina; and drying the applied second coating liquid to form the first ink absorbing layer.

Examples of the major component of the first dispersion include: a dispersion obtained by mixing a silanol-modified polyvinyl alcohol solution with a dispersion of polyaluminum chloride, pseudo boehmite alumina and optionally used various additives to form a gel and chopping the resulting gel in a ultra-high-speed stirrer such as a homogenizer to disperse in water; and a dispersion of fine particles of a gel obtained by adding either of a solution of the hydrophilic polymer or a dispersion of the inorganic fine particles with the other which is under stirring at high speed, and adding thereto polyaluminum chloride. Herein, the timing to add the various additives to be added as needed is not particularly limited. The first dispersion can be obtained by preparing the composition in a dispersed state.

The gel is preferably a gel with substantially no tackiness. When the thus-formed gel is tacky, it can be difficult to finely disperse the gel, and dispersed particles may adhere to each other to aggregate even after the dispersing, which may make the dispersion be unstable.

The second dispersion can be prepared by mixing pseudo boehmite alumina having a secondary particle diameter of 80 nm or less, a polyvinyl alcohol solution, boric acid, and a water-soluble zirconium salt, and various optional additives as needed, in a conventional manner. It is also possible to firstly mix the components other than boric acid and introduce thereinto boric acid by an inline addition upon coating of the dispersion.

Examples of the solvent to be used for preparing the first and the second dispersions include water, an organic solvent, and a mixture solvent thereof. Examples of the organic solvent to be used for coating of the dispersions include alcohols (e.g., methanol, ethanol, n-propanol, i-propanol, and methoxypropanol), ketones (e.g., acetone and methyl ethyl ketone), tetrahydrofuran, acetonitrile, ethyl acetate, and toluene.

Methods for coating the first and the second dispersions which can be employed include various coating methods such as E-bar coating, curtain coating, straddle hopper coating, extrusion coating, roll coating, air knife coating, gravure coating or rod bar coating.

The first and the second dispersion may be coated by simultaneous double layer coating. The simultaneous double layer coating can be performed using a known coating machine such as a slide bead coater, a curtain flow coater, or an extrusion die coater.

The first dispersion coated is preferably coated so that the amount of pseudo boehmite alumina becomes 0.5 g/m². The second dispersion is preferably coated so that the amount of solid components thereof becomes 20 g/m² or more, and is more preferably coated so that the amount of solid components thereof becomes in a range of 25 g/m² to 60 g/m².

Common known methods can be employed as means for drying of the dispersion after the coating without particular limitation. Examples thereof include a method having conveying the coated resultant into a heating chamber in which a heated air generated by a heat source is introduced, and a method having passing the coated resultant through the vicinity of a heat source such as a heater.

### EXAMPLES

The present invention will be explained in more detail by way of examples, which are not intended to be limiting of the invention. The “parts” and “%” are on mass basis unless otherwise noted.

### Example 1

### Preparation of Dispersion of Alumina hydrate (pseudo boehmite alumina) for First Ink Absorbing Layer

114.5 kg of ion exchanged water was added to a suction disperser (trade name: CONTI-TDS, manufactured by DALTON), and 20.2 kg of CATALOID AP-5 (trade name, manufactured by Catalysts & Chemicals Industries Co., Ltd.; pseudo boehmite alumina having primary particle size of 8 nm) was added thereto by portions under stirring at the maximum rotation number of the device to obtain a white coarse dispersion of pseudo boehmite alumina. The time required for the dispersing procedure was 35 minutes. This white coarse dispersion of pseudo boehmite alumina was subjected to fine dispersing in a high-pressure disperser (trade name: ULTIMIZER HJP25005, manufactured by Sugino Machine Limited) to obtain a transparent pseudo boehmite alumina dispersion containing 32% by mass of solid content. In this procedure, the applied pressure was 100 MPa, and the ejecting amount was 600 g/min. The particle diameter of the resulting transparent dispersion of pseudo boehmite alumina was 0.050 μm.

Preparation of Dispersion A for Forming First Ink Absorbing Layer

10 parts of a 10% by mass of aqueous solution of polyvinyl alcohol (trade name: PVA1 10, manufactured by KURARAY CO., LTD.) was mixed with respect to 100 parts of the alumina hydrate dispersion (the transparent pseudo boehmite alumina dispersion containing 32% by mass of solid content), and then the resulting mixture was mixed with 5 parts of a 10% by mass of aqueous solution of silanol-modified polyvinyl alcohol (trade name: R-1130, manufactured by KURARAY CO., LTD.). After the mixing, the resulting mixture was uniformly dispersed in a homomixer at a rotation of 10,000 rpm for 10 minutes. 5 parts of a solution of polyaluminum hydroxide (trade name: PURACHEM WT; manufactured by RIKENGREEN CO., LTD.) was added to this dispersion by portions to prepare a gel dispersion, followed by adding thereto 10 parts of a 10% by mass aqueous solution of polyvinyl alcohol (PVA110; described above) as an adhesive to prepare a dispersion A for forming a first ink absorbing layer.

Preparation of Dispersion of Alumina Hydrate (pseudo boehmite alumina) for Second Ink Absorbing Layer

40.2 kg of ion exchanged water was added to a suction disperser (trade name: CONTI-TDS, manufactured by DALTON), and 20.2 kg of CATALOID AP-5 (trade name, manufactured by Catalysts & Chemicals Industries Co., Ltd.; pseudo boehmite alumina having primary particle size of 8 nm) was added thereto by portions under stirring at the maximum rotation number of the device to obtain a white coarse dispersion of pseudo boehmite alumina. The time required for the dispersing procedure was 35 minutes. This white coarse dispersion of pseudo boehmite alumina was subjected to fine dispersing in a high-pressure disperser (trade name: ULTIMIZER HJP25005, manufactured by Sugino Machine Limited) to obtain a transparent pseudo boehmite alumina dispersion containing 32% by mass of solid content. In this procedure, the applied pressure was 100 MPa, and the ejecting amount was 600 g/min. The particle diameter of the resulting transparent dispersion of pseudo boehmite alumina was 0.050 μm.

Preparation of Dispersion B for Forming Second Ink Absorbing Layer

2500 g of the thus-prepared dispersion of pseudo boehmite alumina, 1062.5 g of ion exchanged water, 33 g of zirconium acetate (trade name: ZIRCOSOL ZA30, manufactured by DAIICHI KIGENSO KAGAKU KOGYO CO., LTD.), 1104 g of polyvinyl alcohol having a saponification degree of 88% and a polymerization degree of 3500 (trade name: PVA235, manufactured by KURARAY CO., LTD.), and 6.8 g of a 10% of aqueous solution of surfactant (trade name: SWANOLAM2150, manufactured by Nikko Chemicals Co., Ltd.) were respectively incubated at a temperature of 50° C. and then mixed with each other to obtain a dispersion B for forming a second ink absorbing layer. The secondary particle diameter of pseudo boehmite alumina in the dispersion B for forming the second ink absorbing hayer was 0.060 μm.

Preparation of Polyolefin Resin-Coated Paper (Non-Water-Absorbing Support)

A 1:1 mixture of broadleaf bleached kraft pulp (LBKP) and a broadleaf bleached sulfite pulp (LBSP) was beaten to have a freeness of 300 ml in terms of Canadian Standard Freeness (C.S.F.) to prepare pulp slurry. An alkyl ketene dimer, which works as a sizing agent, with an amount of 0.5% based on the pulp respectively, polyacrylamide, which works as a reinforcing agent, with an amount of 1% based on the pulp, cationized starch with an amount of 2% based on the pulp, and a polyamide epichlorohydrin resin with an amount of 0.5% based on the pulp were added to the slurry, and the resulted mixture was diluted with water to prepare a slurry having the beaten pulp concentration of 1%. This slurry was subjected to a fourdrinier paper machine to form paper having a basis weight of 170 g/m², followed by drying and humidity conditioning, to produce a base paper for forming a polyolefin resin-coated paper. A polyethylene resin composition, which is formed by uniformly dispersing, to a 100 mass% of a low-density polyethylene having a density of 0.918 g/cm³, 10 mass % of anatase titanium, was melted at 320° C., extruded at 200 m/min to be a layer having a thickness of 35 μm provided onto a printing side of the produced base paper, and cooled on a minutely roughened cleaning roll, to form a resin coating layer which resides at a side of a polyolefin resin-coated paper to which an ink receiving layer is to be provided. Similarly, a resin composition prepared by blending 70 parts of a high-density polyethylene resin having a density of 0.962 g/cm³ with 30 parts of a low-density polyethylene resin having a density of 0.918 g/cm³ was melted at 320° C. and extrusion-coated to be a layer having a thickness of 30 μm provided onto the reverse surface of the base paper with a roughened cleaning roll to form a resin reverse surface of the polyolefin resin-coated paper.

The side of the polyolefin resin-coated paper to be provided with an ink receiving layer was subjected to high-frequency corona discharge treatment, and then applied with an undercoat layer having the following formulation so that the coating amount of gelatin per square meter became 50 mg/m², followed by drying to form an undercoat layer thereon. A support was prepared as a result.

Formulation of Undercoat Layer

| | | |
|---|---|---|
| Lime-treated gelatin | 100 | parts |
| 2-Ethylhexyl sulfosuccinate | 2 | parts |
| Chrome alum | 10 | parts |

Each of the dispersion A for forming the first ink absorbing layer and the dispersion B for forming the second ink absorbing layer was incubated at 50° C. 188 g of a 7.5% of boric acid aqueous solution incubated at 50° C. was inline-added to 4669 g of the dispersion B for forming the second ink absorbing layer, and then simultaneous double layer coating was performed so that the dispersion B for forming the second ink absorbing layer and the dispersion A for forming the first ink absorbing layer were applied onto a support in this order from the support side using a slide bead coating machine, followed by set drying for 2 minutes so that the temperature of the film surface of the coated product becomes 20° C.

Subsequently, the coated product was dried at 80° C. for 10 minutes to provide an inkjet recording medium 1. The coated amounts of the pseudo boehmite alumina in the first ink absorbing layer and in the second ink absorbing layer were 0.3 g/m² and 39 g/m², respectively.

### Example 2

An inkjet recording medium 2 was prepared in the same manner as the inkjet recording medium 1 in Example 1, except that the coated amount of the pseudo boehmite alumina in the first ink absorbing layer was changed to 0.6 g/m².

### Comparative Example 1

An inkjet recording medium 3 was prepared in the same manner as the inkjet recording medium 1 in Example 1, except that the first ink absorbing layer was not provided thereto.

### Comparative Example 2

Preparation of an inkjet recording medium 4 was tried in the same manner as the inkjet recording medium 1 in Example 1, except that the inline-addition of the boric acid aqueous solution was omitted. However, a sample of the inkjet recording medium 4 could not be obtained since coated film layer was peeled off during the set drying.

### Comparative Example 3

An inkjet recording medium 5 was prepared in the same manner as the inkj et recording medium 1 in Example 1, except that the coated amount of the pseudo boehmite alumina in the first ink absorbing layer was changed to 20 g/m², and the second ink absorbing layer was not provided thereto.

### Comparative Example 4

An inkj et recording medium 6 was prepared in the same manner as the inkjet recording medium 1 in Example 1, except that the dispersion of pseudo boehmite alumina added to the dispersion B for forming a second ink absorbing layer was changed to the one prepared as follows.

Preparation of Dispersion of Alumina Hydrate (pseudo boehmite alumina) for Second Ink Absorbing Layer of Comparative Example 4

40.2 kg of ion exchanged water was added to a suction disperser (trade name: CONTI-TDS, manufactured by DALTON), and 20.2 kg of CATALOID AP-5 (trade name, manufactured by Catalysts & Chemicals Industries Co., Ltd.; pseudo boehmite alumina having primary particle size of 8 nm) was added thereto by portions under stirring at the maximum rotation number of the device to obtain a white coarse dispersion of pseudo boehmite alumina. The time required for the dispersing procedure was 35 minutes. The particle diameter of the resulting white coarse dispersion of pseudo boehmite alumina was 0.120 μm. The secondary particle diameter of pseudo boehmite alumina in a dispersion B for forming the second ink absorbing layer prepared by using the resulting white coarse dispersion of pseudo boehmite alumina was 0.120 μm.

### Comparative Example 5

An inkj et recording medium 7 was prepared in the same manner as the inkjet recording medium 1 in Example 1, except that the mixing-addition of the zirconium acetat was omitted.

### Comparative Example 6

### Preparation of Dispersion of Fumed Silica

40.2 kg of ion exchanged water was added to a suction disperser (trade name: CONTI-TDS, manufactured by DALTON), and 7.1 kg of AEROSIL 300 (trade name, manufactured by NIPPON AEROSIL Co., Ltd.; fumed silica having primary particle size of 7 nm) was added thereto by portions under stirring at the maximum rotation number of the device to obtain a white coarse dispersion of fumed silica. The time required for the dispersing procedure was 3 minutes.

This white coarse dispersion of fumed silica was subjected to fine dispersing in a high-pressure disperser (trade name: ULTIMIZER HJP25005, manufactured by Sugino Machine Limited) to obtain a transparent fumed silica dispersion containing 15% by mass of solid content. In this procedure, the applied pressure was 100 MPa, and the ejecting amount was 600 g/min. The particle diameter of the resulting transparent dispersion of fumed silica was 0.120 μm.

Preparation of Dispersion C for Forming Second Ink Absorbing Layer

950 g of the dispersion of fumed silica, 84.8 g of ion exchanged water, 85 g of a boric acid solution (concentration: 7.5% by mass), and 123.5 g of 59% solution of ethanol solvent (trade name: SOLMIX AP-7, manufactured by NIPPON ALCOHOL HANBAI COMPANY) were mixed under stirring with a dissolver. Further, 498.5 g of a 7% aqueous solution of PVA235 (trade name, manufactured by KURARAY CO., LTD.; saponification degree: 88%; polymerization degree: 3500) and 12.2 g of a 10% of aqueous solution of a surfactant (trade name: SWANOL AM2150, manufactured by Nikko Chemicals Co., Ltd.) were added thereto, followed by mixing and stirring for 10 minutes in the dissolver so as to provide a dispersion C for forming a second ink absorbing layer. The secondary particle diameter of the fumed silica in the dispersion C for forming the second ink absorbing layer was 0.120 μm.

A polyolefin resin-coated paper was prepared in the same manner as in Example 1, and an undercoating layer was provided to the polyolefin resin-coated paper in the same manner as in Example 1 to prepare a support.

The dispersion C for forming the second ink absorbing layer was incubated at a temperature of 30° C. and coated on the support using a slide bead coating machine, followed by set drying for 2 minutes so that the temperature of the film surface of the coated product becomes 20° C. Subsequently, the coated product was dried at 80° C. for 10 minutes to provide an inkjet recording medium 8. The coated amount of the fumed silica was adjusted to be 19 g/m².

### Comparative Example 7

Preparation of an inkjet recording medium 9 was tried in the same manner as the inkj et recording medium 1 in Example 1, except that the addition of the polyaluminum hydroxide in the preparation of the dispersion A for forming a first ink absorbing layer was omitted. However, a sample of the inkjet recording medium 9 which can be subjected to the following evaluation tests could not be obtained since its coated film layer was too brittle.

### Comparative Example 8

Preparation of an inkjet recording medium 10 was tried in the same manner as the inkj et recording medium 1 in Example 1, except that 5 parts of a 10% by mass of aqueous solution of polyvinyl alcohol (trade name: PVA 117, manufactured by KURARAY CO., LTD.) was used in place of the 5 parts of a 10% by mass of aqueous solution of silanol-modified polyvinyl alcohol (trade name: R-1130, manufactured by KURARAY CO., LTD.) in the preparation of the dispersion A for forming a first ink absorbing layer. However, the thus-obtained inkjet recording medium 10 did not have ink absorbing property and thus could not record an image to be printed thereon.

Evaluations

Each of the inkj et recording media was subjected to evaluations with respect to bronzing, image density of printed image, and change in color hue. The results thereof are shown in the following Tables 1 and 2.

Evaluation of Bronzing

A solid image of cyan color was printed on each of the inkjet recording media by using an inkjet printer (trade name: PM-A820, manufactured by Seiko Epson Corporation) under the condition of 35° C. and 80% RH. The thus-obtained cyan solid image in the printed area was visually observed under a fluorescent lamp to be evaluated on the basis of the following evaluation criteria.

### Evaluation Criteria:

A: Fluorescent light reflected by the image maintains whiteness and does not look reddish.

B: Fluorescent light reflected by the image slightly looks reddish.

C: Fluorescent light reflected by the image partially looks reddish.

D: Fluorescent light reflected by the image entirely looks reddish.

Evaluation of Image Density

Solid images having a color of yellow, magenta, cyan, or black were respectively printed on each of the inkj et recording media by using an inkj et printer (trade name: PM-A820, manufactured by Seiko Epson Corporation). Image density of each of the black (Bk), yellow (Y), magenta (M), and cyan (C)-colored solid images in printed areas was measured under the condition with 2° of viewing angle and D50 of light source by using SPECTROLINO SPM50 (trade name, manufactured by GretagMacbeth) without using a filter.

Evaluation of Change in Color Hue

A gray solid image was printed on each of the inkjet recording media by using an inkjet printer (trade name: PM-A820, described above). Herein, the gradation of the image data was adjusted so that the gray density becomes 1.7. Color hue of the gray area in the printed image was measured immediately after the printing and after 24 hours of the printing, and the color difference (AE) between the color hues measured immediately after the printing and that measured after 24 hours of the printing was calculated for evaluating the color hue change.

Here, the measurement of the colour phase was performed by measuring L*a*b* under conditions of F8 for light source and 2 degree for viewing angle with a spectrophotometer (trade name: SPECTROLINO, manufactured by GretagMacbeth). The property to suppress the change in color hue was evaluated from the color difference (AE) thus obtained in accordance with the following evaluation criteria. Evaluation results are shown in Tables 1 and 2. Evaluation criteria:

A . . . ΔE≦2: Changes in the color hue are hardly observed.

B . . . 2<ΔE≦4: Changes in the color hue are observed, but they are unnoticeable (within allowable range from practical viewpoint).

C . . . 4<ΔE≦7: Changes in the color hue are remarkably noticeable (beyond the allowable range from practical viewpoint).

D . . . 7<ΔE: Changes in the color hue are big and a problematic level.

TABLE 1

| | | | | Comparative | Comparative | Comparative |
|---|---|---|---|---|---|---|
| | Example 1 | | Example 2 | example 1 | example 2 | example 3 |
| First ink | Binder | R1130 | R1130 | | R1130 | R1130 |
| absorbing | Polyaluminum chloride | PURACHEM | PURACHEM | | PURACHEM | PURACHEM |
| layer | | WT | WT | | WT | WT |
| | Coated amount of Pseudo boehmite alumina | 0.3 g/m² | 0.6 g/m² | | 0.3 g/m² | 20 g/m² |
| Second ink | Particle diameter of Pseudo boehmite alumina | 60 nm | 60 nm | 60 nm | 60 nm | |
| absorbing | PVA | PVA235 | PVA235 | PVA235 | PVA235 | |
| layer | Amount of boric acid | 0.5 g/m² | 0.5 g/m² | 0.5 g/m² | None | |
| | Zirconium salt | ZIRCOSOL | ZIRCOSOL | ZIRCOSOL | ZIRCOSOL | |
| | | ZA30 | ZA30 | ZA30 | ZA30 | |
| Bronzing | | B | B | D | Film is | B |
| Image | Y | 1.6 | 1.6 | 1.6 | peeled off. | 1.50 |
| density | M | 1.05 | 1.05 | 11.06 | | 0.9 |
| | C | 0.49 | 0.48 | 0.5 | | 0.4 |
| | K | 2.81 | 2.75 | 2.88 | | 1.9 |
| Change in | ΔE | A | A | A | | B |
| Color hue | | | | | | |

TABLE 2

| | | Comparative | Comparative | Comparative | Comparative | Comparative |
|---|---|---|---|---|---|---|
| | | example 4 | example 5 | example 6 | example 7 | example 8 |
| First ink | Binder | R1130 | R1130 | | R1130 | PVA117 |
| absorbing | Polyaluminum chloride | PURACHEM | PURACHEM | | | PURACHEM |
| layer | | WT | WT | | | WT |
| | Coated amount of Pseudo boehmite alumina | 0.3 g/m² | 0.3 g/m² | | 0.3 g/m² | 0.3 g/m² |
| Second | Particle diameter of Pseudo boehmite alumina | 120 nm | 60 nm | fumed silica | 60 nm | 60 nm |
| ink | | | | 120 nm | | |
| absorbing | PVA | PVA235 | PVA235 | PVA235 | PVA235 | PVA235 |
| layer | Amount of boric acid | 0.5 g/m² | 0.5 g/m² | 0.5 g/m² | 0.5 g/m² | 0.5 g/m² |
| | Zirconium salt | ZIRCOSOL | | | ZIRCOSOL | ZIRCOSOL |
| | | ZA30 | | | ZA30 | ZA30 |
| Bronzing | | B | B | B | Film is too | Poor ink |
| Image | Y | 1.55 | 1.55 | 1.55 | brittle. | absorption |
| density | M | 1.03 | 1.03 | 1.03 | | |
| | C | 0.48 | 0.48 | 0.48 | | |
| | K | 2.58 | 2.60 | 2.55 | | |
| Change in | ΔE | A | B | B | | |
| Color hue | | | | | | |

What is claimed is:

1. An ink jet recording medium comprising at least two ink absorbing layers provided on or above a non-water-absorbing support, wherein:
a first ink absorbing layer, which is provided uppermost among the at least two ink absorbing layers, comprises silanol-modified polyvinyl alcohol, polyaluminum chloride and pseudo boehmite alumina, and
a second ink absorbing layer, which is adjacent to the first ink absorbing layer, comprises pseudo boehmite alumina having a secondary particle diameter of 80 nm or less, polyvinyl alcohol, boric acid, and a water-soluble zirconium salt.

2. The ink jet recording medium of claim 1, wherein the content of the pseudo boehmite alumina in the first ink absorbing layer is less than 0.5 g/m².

3. A method of manufacturing an ink jet recording medium comprising at least two ink absorbing layers provided on or above a non-water-absorbing support, the method comprising:
applying, on or above the non-water-absorbing support, a first coating liquid comprising pseudo boehmite alumina having a secondary particle diameter of 80 mn or less, polyvinyl alcohol, boric acid, and a water-soluble zirconium salt;
drying the applied first coating liquid to form a second ink absorbing layer, which is adjacent to a first ink absorbing layer to be provided uppermost among the at least two ink absorbing layers;
applying, above the non-water-absorbing support, a second coating liquid comprising silanol-modified polyvinyl alcohol, polyaluminum chloride and pseudo boehmite alumina; and
drying the applied second coating liquid to form the first ink absorbing layer.

4. The method of manufacturing an ink jet recording medium of claim 3, wherein the content of the pseudo boehmite alumina in the first ink absorbing layer is less than 0.5 g/m².
